(19) United States
(12) Patent Application Publication
(10) Pub. No.: US 2005/0183028 A1
(43) Pub. Date: Aug. 18, 2005

(54) System and method for acquisition and analysis of time and location-specific data

(76) Inventors: Bradford Addison Clough, Largo, FL (US); Greg Jesse Paulk, Las Vegas, NV (US)

Correspondence Address: LEWIS AND ROCA LLP, 40 NORTH CENTRAL AVENUE, PHOENIX, AZ, 85004, US

(21) Appl. No.: 10/940,353

(22) Filed: Sep. 13, 2004

Related U.S. Application Data
(60) Provisional application No. 60/501,930, filed on Sep. 11, 2003.

(51) Int. Cl. G06F 17/00; G06F 9/00; G06F 3/00; E03F 3/06; F16L 1/024

(52) U.S. Cl. 715/771; 715/704; 715/705; 715/772; 715/839; 715/719

(57) ABSTRACT

The system and method of the present invention presents a means to access and review recorded data in a manner that supports analysis of the condition of infrastructure systems such as sewer pipes or other piping systems. The present invention further provides the ability to view a particular location in a piping system or data set at varying points in time, thereby supporting an analysis of the deterioration and likely repair priority of a particular section of infrastructure.

### CROSS REFERENCES TO RELATED APPLICATIONS

This application claims the full benefit and priority of U.S. Provisional Application Ser. No. 60/501,930, filed on Sep. 11, 2003, the disclosure of which is fully incorporated herein for all purposes.

### STATEMENT REGARDING FEDERALLY SPONSORED RESEARCH OR DEVELOPMENT

Not Applicable.

### BACKGROUND OF THE INVENTION

1. Field of the Invention

This invention relates to graphical systems for managing the acquisition, storage, and presentation of video. More specifically, one embodiment of this invention provides a graphical system that manages the acquisition, storage and presentation of video and correlates various graphical and logical representations of an object over a period of one or more time frames.

2. Description of the Related Art

The maintenance of piping systems, sewer systems, conduit runs, and other major infrastructure elements has been an ongoing challenge that faces most cities and towns. Over time, installed infrastructure systems are subject to deterioration from adverse events such as corrosion and oxidation, stress fracture, incursion by natural plant action (e.g. root incursion), and physical damage from human activities such as trenching. A variety of well-known techniques have evolved to survey the condition of major infrastructure systems, and to allow engineers to review the current state of a given system in order to prevent or mitigate damage to the system.

Many municipalities perform periodic inspections of sewer lines by instructing field inspection crews to videotape the inside of the sewer lines and then having engineers review these video tapes to assess the condition and defects in the sewer lines and to recommend whatever actions are necessary to repair any defects. An example of a pipeline data collection and display system that may be used to obtain video footage of the interior of a sewer line is described in U.S. Pat. No. 4,974,168, the disclosure of which is fully incorporated herein for all purposes. In this disclosed system, a field inspection crew positions a van FIG. 1 (11) including the inspection equipment, close to a manhole entry (16) of a sewer line (15) to be inspected. First, the crew backwashes the sewer line, and then sets up the inspection equipment as shown in FIG. 1, by placing a surface roller assembly (18) at the opening of manhole entry (16) and placing a wind-up winch assembly (21) at the opening of an adjacent manhole entry (17). A tow cable (22) extending from wind-up winch assembly (21) is passed through a manhole down roller assembly (20) and connected to a monitoring device (14), which includes a video camera. A cable assembly (12) coupled at one end to electronic survey equipment (43) located in van (11), is passed down through surface roller assembly (18) and a manhole down roller assembly (19) and coupled to an opposite end of monitoring device (14).

Having described the physical assembly of a typical field inspection system, one manner by which the video information is obtained, processed, taped, reviewed, and subsequently archived will now be described with reference to FIG. 2. As the field inspection crew moves monitoring device (14) through the sewer line, the video footage obtained from the video camera is fed to a display device and monitored by an operator in van (11) (step 52). While monitoring the video footage, the operator prepares a handwritten logsheet identifying the suspected defects and anomalies and their location in the sewer line (step 54). Some of this information written on the logsheet may be entered on a keyboard such that the system may generate and overlay graphics showing this information on the video footage to which it pertains (step 56). The video footage is recorded on a video tape along with the overlaid graphics using a video cassette recorder (VCR) (step 58). Then after the field inspection crew has filmed the designated portion of sewer line 15, it sends the video tape and the handwritten logsheet to an engineer typically employed by the municipality (step 60).

The engineer's job is to review the field inspection videos supplied by the inspection crew and to recommend what action is to be taken to repair any confirmed defects or anomalies. To perform this task, the engineer will place the video tape in a VCR and review the logsheet to determine whether there are any suspected defects in the sewer line, provided of course that the logsheet is still with its associated video tape. Then the engineer fast-forwards, pauses, and rewinds the video tape to locate the video footage corresponding to each suspected defect indicated on the associated logsheet (step 62). Based upon the review of the video tape, the engineer writes a report identifying each defect and recommending a course of action to repair the defect (step 64). Provided the recommended course of action can be carried out within the municipality's budget, the municipality will accept bids from contractors to repair the sewer line (step 66). Then after a bid is accepted, a contractor will repair the sewer line in accordance with the engineer's recommended course of action (step 68) and the municipality will dispatch the field inspection crew to again video tape the repaired sewer line so that the engineer can review the contractor's work to ensure that the sewer line was repaired properly (step 70). After this process is completed, the logsheet, videotapes, and engineering reports are archived typically by placing the paper documents within the video tape slip cover along with the video tape and placed on a shelf (step 72).

In the past, pipe inspection was generally the responsibility of engineers who viewed video that was recorded in the field by the inspection crew as described above. The process of video pipe inspection has evolved with time placing more and more responsibility on the individual inspector that records the video and observations. For this reason many municipalities now require that such individuals be certified by the National Association of Sewer Service Companies (NASSCO) or some similar organization. Although such organizations provide uniformity by defining a set of standard observations, the number of standard observations reach in to the tens of thousands. The hundreds of rules, variables and modifiers further complicate the task. Therefore, what is needed is a means for guiding the field inspector to select the appropriate standardized inspection observation quickly and accurately.

Since the methodology described in regards to U.S. Pat. No. 4,974,168 requires an engineer to fast-forward and rewind the video tape to find those portions within the video that show the suspected defects listed on the logsheet, other prior art approaches were developed to attempt to mitigate such problems. In one such approach, described in U.S. Pat. No. 6,175,380, the disclosure of which is fully incorporated by reference herein for all purposes, the video information along with representations of logsheets are stored digitally to make subsequent access less tedious and time consuming for the reviewing engineer. While such digital storage and processing of video information may reduce the time needed for the reviewing engineer to review the video information, there is no ready means for the reviewing engineer to easily discern the condition of a particular component of the infrastructure system over several points in time. Therefore a need exists to correlate video or other condition-related data with both a state in time and physical location of a component of an infrastructure system such as a sewer system. There is a further need to organize and track a wide variety of data such as audio data, textual data, graphical data, condition codes, and online media and correlate those data sources with one or more physical locations at one or more points in time.

### SUMMARY OF THE INVENTION

The system and method of the present invention presents a means to access and review recorded data in a manner that supports analysis of the condition of infrastructure systems such as sewer pipes or other piping systems. The present invention further provides the ability to view a particular location in a piping system or data set at varying points in time, thereby supporting an analysis of the deterioration and likely repair priority of a particular section of infrastructure. It is an object, therefore of the present invention to provide for viewing multiple time-dependent representations of a physical object in an infrastructure system. It is an additional object of the present invention to provide for the integration and correlation of multiple data objects with points in time and in physical space. It is an additional object of the present invention to provide for the automated gathering of infrastructure-related information, and correlation of this information with physical locations and points in time. It is an additional object of the present invention to integrate industry standard codes and/or icons into a computer-based interface to streamline inspection, observation, data collection and categorization.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 illustrates a prior art figure of a field inspection system for inspecting an infrastructure element such as a sewer line;

FIG. 2 illustrates a prior art flow diagram for a method of manually collecting and reviewing fined inspection video information;

FIG. 3 illustrates one embodiment of the present invention whereby an overview of data collection, storage and review is presented;

FIG. 4 represents one embodiment of the present invention whereby an element on a Graphical Information System (GIS) or schematic is being accessed via selection of a view tool icon;

FIG. 5 illustrates one embodiment of the present invention whereby a cursor indicia is modified to indicate transition into a view query mode in a GIS;

FIG. 6 illustrates one embodiment of the present invention that shows a video image of a section of pipe, a selection pane for time-related video image collections, and selected pipe features available for viewing;

FIG. 7 displays one embodiment of the present invention whereby a user selects a pipe, manhole or any other feature on a GIS map and a list of video and media associated with the selected feature is presented;

FIG. 8 illustrates one embodiment of the present invention whereby a user gains access to multiple time-diverse videos to compare original as-built video to recent damage assessment video;

FIG. 9 displays one embodiment of the present invention whereby a user selects a graphical depiction in a selection pane of an element of a piping system, and a video is displayed of the physical representation of the selected graphical depiction; and

FIG. 10 further illustrates selection of a graphical defect representation such as a crack and a video being displayed that corresponds to the selected defect.

### DETAILED DESCRIPTION OF THE DISCLOSED INVENTION

Reference will now be made in detail to exemplary embodiments of the invention, examples of which are illustrated in the accompanying drawings. Wherever possible, the same reference numbers will be used throughout the drawings to refer to the same or like parts.

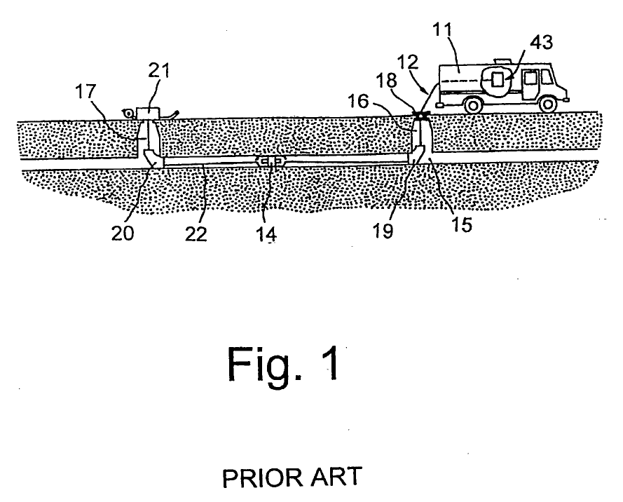

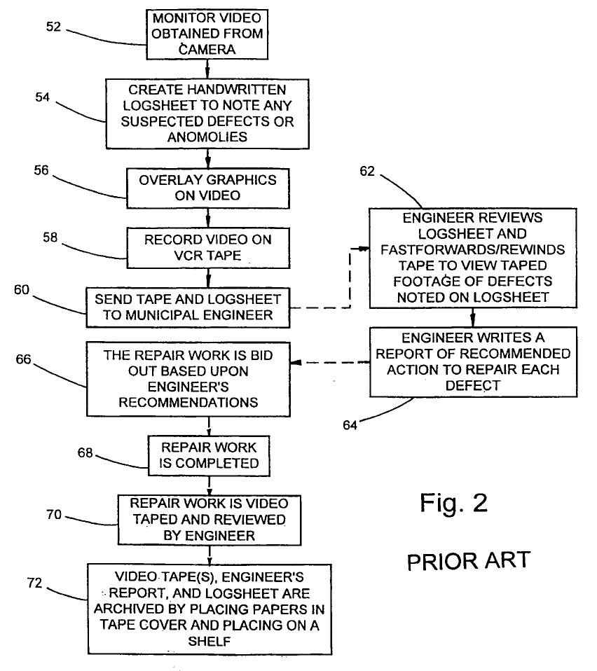

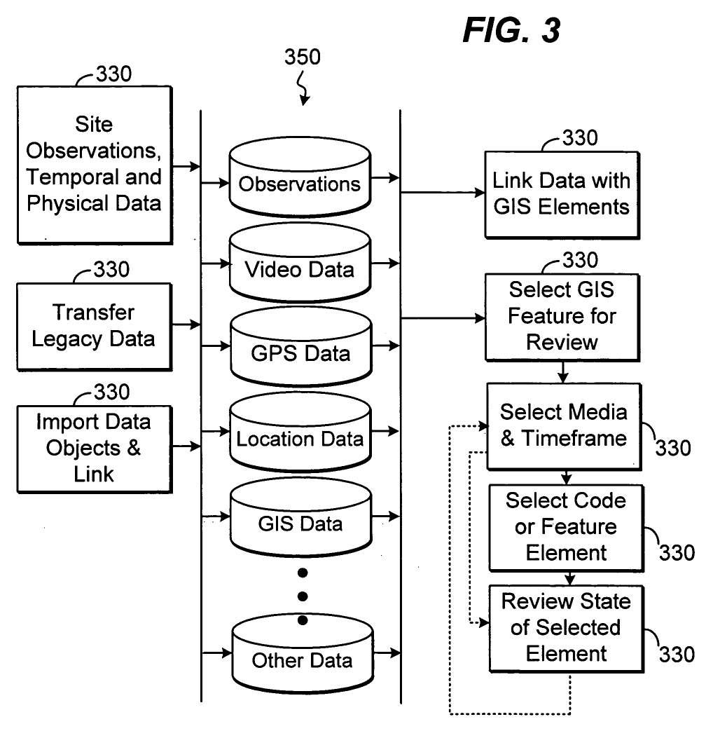

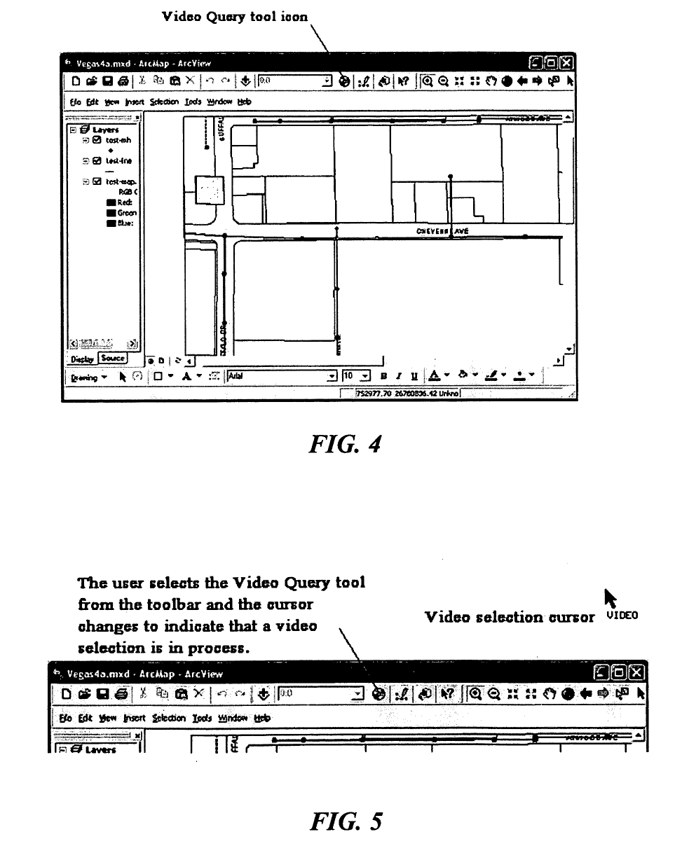

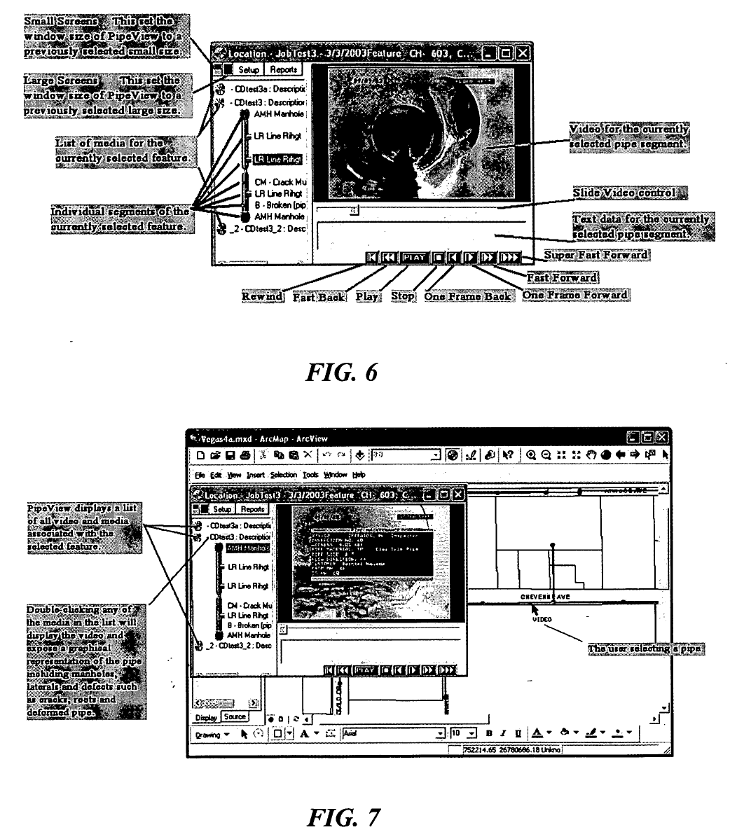

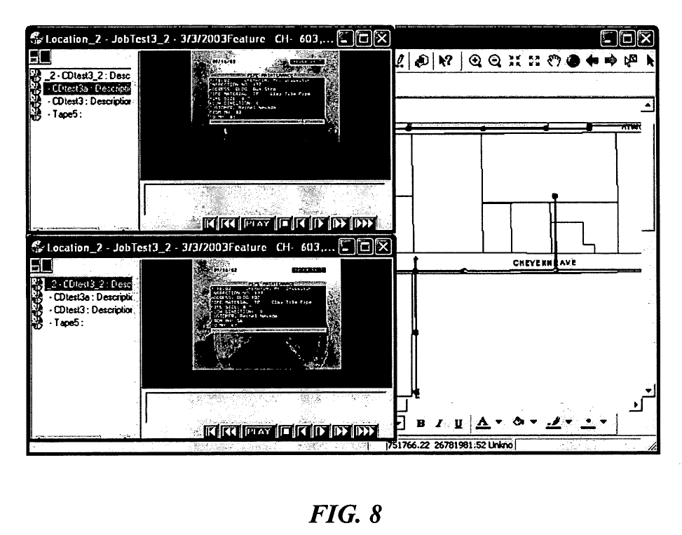

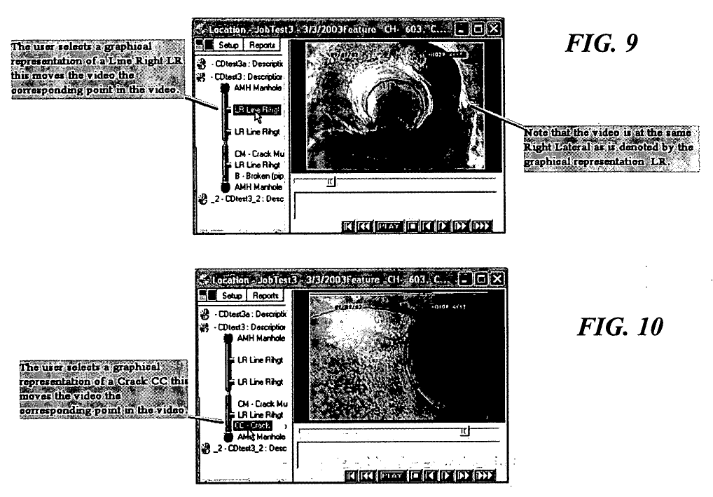

There is provided a system and method for acquisition and analysis of time and location-specific data. Turning to FIG. 3, an overview of a data flow of one embodiment the present invention (300) is presented. As was described above regarding FIGS. 1 and 2, an inspection of a physical location provides for the acquisition and/or generation of data such as observations, defect reports or videos of an infrastructure element (305). In the present invention, such data is correlated with the physical location of each item being recorded, such as a manhole location in a sewer system, and further correlated (or associated) with the date/time the data was collected (305). The system (300) also provides for the transfer (315) of legacy data such as videotape or CD/DVD libraries into the one or more databases (310). The system (300) also provides for the input and linking of data objects (320) that may comprise status indicators, inspection notes, observation or classification data, or analysis results. From the databases (310) the present invention allows the linkage (325) of data stored within databases (310) with graphical information system (GIS) elements such as pipe segments, valves, or manholes. In one method of use of the present invention a user selects a feature shown on a GIS schematic or map for review (330) (See also FIG. 4, FIG. 5). A list of available data sources or media choices is then presented along with state/time data properties and a graphical and/or code (e.g. NASSCO code) representations of the physical element (e.g. manholes, laterals, and defects) (see also FIG. 6) and the user selects one of the media files with its associated timeframe (335). The user may then optionally select at least one of the graphical feature/code elements (340) to view media representation (e.g. video) of that element at that point in time (see also FIG. 7). The user may then review the media representation to determine the physical state of the item depicted in the media file corresponding to the graphical feature/code elements (345), and if the user desires, may select a different media and timeframe (335) or may simply select another code or feature to be viewed on the existing media representation (340) (See also FIG. 9, FIG. 10). Alternatively, in one embodiment of the present invention, a plurality of media file representations is available for the user to review, so that the same physical point in space may be reviewed at several different points in time, thus assisting with analysis of time-related wear, corrosion, or other defects (FIG. 8).

By way of further example, the database of the present invention is designed to organize, track and query a wide variety of data including text, audio, multimedia, AVI, Video-Tape, CD, DVD and online media. Because the database is linked by a user selectable field to existing data features of the graphical information system (GIS), no additional data entry is required. The user selects a Video Query tool from the toolbar and the cursor changes to indicate that a video selection is in process. The user then selects the pipe, manhole or any other feature on the GIS map and a list is displayed of all video and media associated with the selected feature. Selecting (e.g. by double clicking) any of the media in the list will display the video and expose a graphical representation of the pipe including manholes, laterals and defects such as cracks, roots and deformed pipe. By selecting any point on this pipe representation the user can view the video for that section of pipe. The graphical representation is made up of a series of drawing objects that represent individual piping elements as well as all the NASCO standard defect codes.

FIG. 4 represents the a tool icon on the application toolbar of the present invention. Further, FIG. 5 illustrates how the selection of the video query tool by the user changes the cursor to indicate that the video selection process has been triggered.

The present invention provides a means of creating virtual objects that contain definable attributes that formulate inherent characteristic of real world objects. For example the virtual objects can describe such characteristics as size, weight, flow rates, electrical resistance and a graphical representation of real world objects and systems. Further the present invention provides a means of associating these virtual objects to data, such as video, in a way that the data can be manipulated. See FIG. 6 further illustrates details of the process and video presentation.

In FIG. 7, the user selects a pipe, manhole or any other feature on the GIS map and the system displays a list of all video and media associated with the selected feature. The ability to associate multiple media and data sources to a particular feature allows the user to view and compare different recordings and data sets.

As illustrated by FIG. 8, and by way of the following scenario, because the present invention may provide for multiple viewers, original as-built video may be compared to more recently obtained video information to provide for damage assessment.

Consider a scenario whereby a video inspection reveals a crack in a section of pipe located between two manholes. Engineering selects the suspect pipe in the GIS system and finds that there are three videos on file that correspond to the section of suspect pipe. One media file represents the as-built state recorded after the pipe was installed, the second represents a previous routine inspection and a third depicts the most current inspection data and media. Viewing the most recent video, an engineer notices an unusual discoloration at the point of the defect. The pipe representation indicates a right lateral just upstream of the defect. By selecting this lateral the engineer views the section of video for that lateral and finds that the discoloration originates from it. The engineer then opens a second window to compare the current video to one which was recorded five years earlier. By selecting the same lateral the engineer can instantly view and compare the previous state of the lateral to the current. The video reveals no discoloration at the lateral and no sign of weakness at the current defect. The engineer also views the as-built video and finds no discoloration at the lateral and no sign of weakness at the current defect. In a matter of minutes the engineer has been able view all of the video relevant to the current defect and determine a course of action. Simply repairing the defect will not resolve the source of the problem. A search of the occupational licenses issued in the past five years for the area fed by the problem lateral returned, among others, a business selling batteries and corrosive acids. Further investigation uncovered acid, lead, zinc and other battery materials located in a storm drain behind the business and supported mitigation efforts to prevent further damage to the piping system.

Two more illustrations (FIG. 9-10) demonstrate an alternate technique of directly accessing video and linked data by selecting graphical representations of segments of pipe that corresponding to the actual pipe. As the user selects different graphical segment representations the video for that segment is displayed, allowing straightforward analysis and navigation of the media data space.

In one embodiment of the present invention, a mapping source is utilized to create relationships between video images and representations of sections of pipe. The mapping source may originate from any number of commercially available or computer-aided engineering or design software tools including, but not limited to ArcView, ArcMap, Pro-E, or AutoCad. After analyzing a representation of a system map with line segments between manhole locations, the present invention associates one or more video depictions of a segment with its mapped equivalent. In this manner, the representation on a map of a segment of a pipe system, for instance, may have associated with it multiple video depictions of that segment, and the user is then able to gain access to views of one or more of the videos associated with a segment through the system map. A user, after being presented with the video depictions that are available for a segment, may click on one or more of those videos for review through, for instance, a display of the video.

In any municipal infrastructure system such as a piping system, it is desirable to be able to track, analyze, and report known data points such as defects like cracks or other failures. In an embodiment of the present invention, the user may perform a query to list the data points that are associated with the represented system (e.g. a piping system). The user has the ability to custom tailor the query or to filter out certain data points based on a list of specified criteria, so that the user may view only a limited set or subset of all possible data points that satisfy the specified criteria. For example, one query may require that only broken pipes be displayed, and therefore defects such as offset joints would not be presented to the user. Another query may ask to see the offset joints only, filtering out all other defects.

Likewise, also disclosed is a means to present an overall rating indicia to the user of the integrity of an element of an infrastructure system, reflecting in a summary fashion, the relative number and severity of defects present in a particular portion of the represented system. As one example, a user could ask for an integrity analysis of one length of pipe in a piping system, and the invention provides to the user an overall rating metric based on the number, types, and severity of defects in that segment of the piping system.

A three-dimensional data acquisition and management system is also disclosed, whereby data is acquired and spatial and temporal parameters are assigned to correlate to information that relates to three-dimensional coordinates. In one embodiment, a Global Positioning System (GPS) is integrated with the data acquisition system, so that as data is measured and acquired, it is assigned spatial coordinates through calibration and use of a portable GPS unit. Likewise, playback or presentation of the three dimensional data can be integrated to a GPS unit, so that as the unit moves, the information depicted to a user, for instance video on a display screen, tracks the motion of the GPS unit.

As an example, consider a robotic video gathering device that is adapted to operate in a system of pipes. The robotic device is configured to acquire data based on its location, possibly through a gyroscopic or inertial instrument calibrated to location via a GPS unit, and also monitors its position in the pipe through techniques such as sonic measurements. As the robot moves through a system of pipes, it records information such as a video of the visual appearance of the piping system, and the recorded information is correlated to position and time of the video, and stored for later presentation and analysis. Since the location data recorded involves three dimensional location information, the depth of the particular display element is also revealed upon playback. Through the integration of a GPS unit into a playback device such as a display screen, a user could walk on ground above a piping system, and view the system as it appears directly below him, the display dynamically scrolling as he walks along. Also, multiple views may be available to the user simultaneously, to see different temporal representations of the data at the same physical location, that is, several views of the same location at different times. In this manner, for instance, a municipal engineer could identify changes in a piping system as the display is traversed through the playback system. Alternatively, the disclosed invention allows a person wishing to mark the location of underground pipes the ability to do so with an increased level of precision of a few inches, compared with prior art systems with resolution limited to several feet. Likewise, the three dimensional aspects of disclosed invention would enable a person to accurately determine and mark depth of the underground structures.

Another feature of the system is its ability to acquire, recall, and manage three dimensional data representing not only of visible elements, but any kind of telemetry including but not limited to heat sensing, ionizing radiation sensing, vibration sensing, infrared sensing, ultraviolet sensing, or other electromagnetic radiation sensing. As an example, a truck utilizing one embodiment of the disclosed invention could drive along a system of power lines, measuring spatial and temporal data correlated with the infrared profile of elements of the power system. Then later, the data could be analyzed, for instance, for elements of the system that were running at a higher operating temperature than at a previous point in time and space, and therefore, a technician could be dispatched to mitigate a potential problem.

Yet another aspect of the disclosed invention is the ability to acquire data and synchronize at varying rates of data acquisition. In one embodiment, high speed video recording (for instance 100-300 frames per second compared with more conventional frame rates of 30 frames per second) could be employed on the underground data acquisition device (or robot), so that the underground robot could traverse the system of pipes at a high rate of speed without losing information on a video recording (e.g. no blurring or skipping of images). In this manner, a benefit is achieved by enabling the mapping of a piping or other system in a greatly reduced period of time. Through the use of a gyro-stabilized and liquid dampened platform, such video could be recorded with clarity in spite of potential unevenness of the base upon which the robot traverses.

In yet another embodiment of the present invention, data acquisition is not just taken from one data source and correlated with spatial and temporal coordinates, but from multiple simultaneous sensors and sources. For an example, a robot as explained above might record a 360-degree view of the pipe as it traversed the system, thereby eliminating the need to stop at lateral junctions and pan a camera in the directions of the laterals. By recording multiple angle views, such as a 360-degree view, the need to stop and pan a camera is eliminated.

In another embodiment of the invention, the recording/acquisition functions and the playback/display/analysis functions are integrated in a comprehensive manner to detect, mitigate, and manage a complex system such as a municipal pipe route. When a potential defect is detected, the previously-acquired data is consulted for comparisons of changes over time, optionally with a step to acquire a current data representation. Analysis then results in the assignment of a resource such as a technician, who is dispatched by the disclosed invention and guided by the disclosed invention to the source of the potential problem by techniques such as an in-vehicle display coupled to a GPS unit. The technician can then make an assessment or diagnosis, using the playback features of the disclosed invention, and possibly acquire new data and transmit the data back to a central location for further analysis. Then, the disclosed invention provides support functions for scheduling a mitigation effort such as an excavation and repair. The system accepts the task, allocates resources, and provides the tracking information to the repair crew to find the source of the problem quickly and efficiently. The repair crew may consult the multiple time/space views of the system in the proximity of the defect, and make improved use of excavation equipment to optimize the repair effort. Likewise, the disclosed invention is not limited to analysis of piping systems, but also allows analysis of other scenarios such as video analysis of a local scene, and may use automatic pattern recognition techniques to identify items of interest in the scene based on changes over time.

In yet another aspect of the present invention, a set of virtual object icons are designated to represent industry-standard elements of the system. For example, in the piping industry, there are codes for standard elements such as a “lateral right” or LR element, that could be associated with a standard icon. The standard virtual object icons are further associated with a set of attributes that are useful in describing the characteristics of that element of the system (for instance, elements of pipe could be assigned attributes such as pitch or diameter). Then, in an embodiment of the present invention, the standard virtual object icons could be interconnected, and the attributes assigned to represent a system as designed or as built. Then the disclosed invention may be used to perform an analysis or simulation of the designed or as-built system, and ascertain performance of the specified system (such as determining flow rates for a proposed design). In this manner, an object oriented design technique commonly used in software development is applied to the design of non-software systems, such systems not limited to piping but representing any number of systems such as electrical distribution systems. Put another way, an aspect of the present invention supports a method of designing and analyzing a system with an object oriented approach by placing properties on a set of standard graphical virtual object icons and interconnecting them, and running analysis and simulation on the system as designed.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

1. A system for analyzing data comprising:
acquisition means for data representing elements of an infrastructure system;
storage means for said data into one or more databases;
correlation means for associating said data with a physical position and a point in time;
selection means for choosing a feature represented on a graphical information system;
means for selecting a media file by an associated timeframe;
means for selecting at least one of a code/feature element; and,
means for reviewing a physical state of an item depicted by a code/feature element.

2. The system of claim 1 further comprising reviewing a plurality of media files corresponding to the same point in space at different points in time.

3. The system of claim 1 further comprising a means to schedule, dispatch, and track problem mitigation resources.

4. The system of claim 1 further comprising means to specify a query list to limit a number of data points displayed to a subset of possible data points.

5. The system of claim 1 further comprising a means to present an overall rating indicia regarding integrity of an element of an infrastructure system.
